(19) United States
(12) Patent Application Publication
(10) Pub. No.: US 2009/0165368 A1
(43) Pub. Date: Jul. 2, 2009

(54) PROCESS AND APPARATUS FOR REFORMING GASEOUS AND LIQUID FUELS

(76) Inventors: Yunquan Liu, Katy, TX (US); Curtis L. Krause, Houston, TX (US); Dennis P. Essl, Sugar Land, TX (US)

Correspondence Address: CHEVRON SERVICES COMPANY;LAW, INTELLECTUAL PROPERTY GROUP, P.O. BOX 4368, HOUSTON, TX, 77210-4368, US

(21) Appl. No.: 12/130,376

(22) Filed: May 30, 2008

Related U.S. Application Data
(60) Provisional application No. 61/017,234, filed on Dec. 28, 2007.

(51) Int. Cl. C10L 1/182

(52) U.S. Cl. 44/451; 44/639

(57) ABSTRACT

A process for transitioning from gaseous fuel reformation to liquid fuel reformation has been invented. The process comprises a series of control steps wherein an autothermal reforming reactor's temperature can substantially be stable and satisfactory hydrogen concentration and selectivity can be achieved for producer gas during the transition process. The temperature is controlled by, for example, adjusting the air and water feed. Formulas and algorithms for writing control programs have also been developed.

### FIELD OF INVENTION

Provided herein is a process for transitioning from gaseous fuel reformation to liquid fuel reformation and vice versa in an autothermal reforming reactor.

### BACKGROUND AND SUMMARY OF THE INVENTION

Autothermal reforming (ATR) processes typically use oxygen or air and carbon dioxide or steam to react with natural gas, i.e. methane, to form syngas. The reaction often takes place in a single chamber reactor where the methane is partially oxidized while it is being reformed. When the ATR uses carbon dioxide the H₂:CO ratio produced is often about 1:1; when the ATR uses steam the H₂:CO ratio produced is often about 2.5:1. The reactions can be described in the following equations, using CO₂:

2CH₄+O₂+CO₂→3H₂+3CO+H₂O+Heat

And using steam:

2CH₄+½O₂+H₂O→5H₂+2CO

The temperatures and pressures of the process could be fairly high as the outlet temperature of the syngas is sometimes as high as 950-1100° C. and the outlet pressure as high as 100 bar.

ATR may also be used for ethanol reforming, as well as, producing certain second generation biofuels, such as dimethyl ether (DME) according to the equation 2CH₃OH→CH₃OCH₃+H₂O. Unfortunately, ethanol reforming and DME production both require a liquid fuel which makes it necessary to use a different autothermal reforming process and apparatus than that employed for conventional natural gas reforming.

It would be advantageous if a process for transitioning from gaseous fuel reformation to liquid fuel reformation and vice versa could be discovered such that the same autothermal reforming reactor could be employed for both gaseous and liquid fuel reformation. It would further be advantageous if such a process was capable of obtaining good H₂ selectivity while also offering high thermal efficiency.

Advantageously, a process for transitioning from gaseous fuel reformation to liquid fuel reformation and vice versa has been discovered that can employ the same autothermal reforming reactor for both gaseous and liquid fuel reformation. The process is capable of obtaining good H₂ selectivity while also offering high thermal efficiency.

In one embodiment, the invention comprises a process for transitioning from gaseous fuel reformation to liquid fuel reformation in a reactor wherein said process comprises:

steadily reforming gaseous fuel by inputting the gaseous fuel into an autothermal reforming reactor;

reducing the gaseous fuel input into the autothermal reforming reactor while increasing the input of a vaporized, superheated liquid fuel/water mixture into the autothermal reforming reactor until a substantial amount of the autothermal reforming reactor input comprises liquid fuel; and

reforming the liquid fuel in the autothermal reforming reactor;

wherein the autothermal reforming reactor temperature is substantially stable during the transition process.

In another embodiment, the invention comprises an apparatus capable of transitioning from gaseous fuel reformation to liquid fuel reformation, said apparatus comprising: a mixer, a vaporizer, a superheater, an air preheater, an autothermal reactor, and a means for maintaining a substantially stable autothermal reforming reactor temperature during the transition process.

### BRIEF DESCRIPTION OF THE DRAWING FIGURES

FIG. 1 is a schematic illustration of a process and apparatus for gaseous fuel (e.g. natural gas) and liquid fuel (e.g. ethanol) reformation described herein.

### DESCRIPTION OF EMBODIMENTS

To facilitate the understanding of the subject matter disclosed herein, a number of terms, abbreviations or other shorthand as used herein are defined below. Any term, abbreviation or shorthand not defined is understood to have the ordinary meaning used by a skilled artisan contemporaneous with the submission of this application.

As used herein, “transition process” refers to a process of converting a fuel reformation process that substantially employs a gaseous fuel such as natural gas to a fuel reformation process that substantially employs a liquid fuel such as ethanol or vice versa.

As used herein, a “substantially stable” temperature is a temperature which does not vary for a substantial amount of time by more than about plus or minus 20° C. of the desired temperature.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

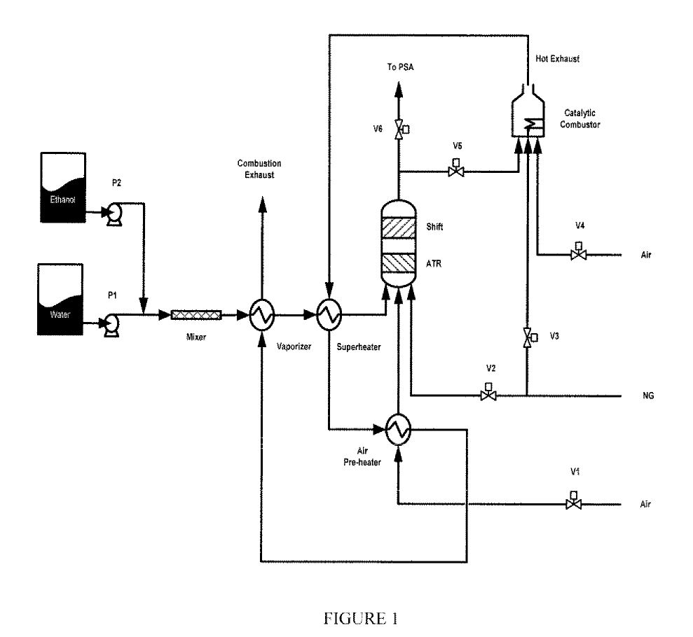

FIG. 1 and the subsequent description illustrates the use of the present invention by reference to a gaseous fuel (natural gas) and a liquid fuel (ethanol) in a specific apparatus. However, the instant invention is applicable to many other liquid fuels (e.g., C₁-C₆ alkanols) and gaseous fuels (e.g., propane) and apparatuses.

As shown in FIG. 1, ethanol is preferably mixed with deionized water before it is vaporized and superheated. This often minimizes coke formation. After vaporization, the ethanol-water mixture is superheated to at least from about 350° C., preferably at least about 375° C. up to about 425° C. before being sent into the ATR reactor for reforming. If desired, the mixture gains further heat by mixing with preheated air. Typically, a catalyst is present in the ATR reactor. In the ATR reactor the preheated air, if present, combusts a portion of the ethanol. Advantageously, this supplies heat for endothermic steam reforming of ethanol.

The ATR reformate then typically enters a shift section. In the shift section a portion of the CO in the reformate is further converted into H₂. After the shift, the H₂-rich stream (reformate) may be sent to a pressure swing adsorption (“PSA”) unit for further purification. Useful PSA units typically have adsorptive materials that selectively adsorb impurities and by-products such as CO and CO₂ and unconverted CH₄ and allow a hydrogen-enriched reformate to pass.

As an alternative to sending the reformate to a PSA, the reformate may be sent into a catalytic combustor after the shift. The catalytic combustor may combust the reformate and generate hot flue gas which can be employed by the reformer to preheat the fuel, water and/or air.

Typically, at start-up natural gas (NG) reforming is conducted first, that is, the ethanol (EtOH) pump P2 is originally at off status. During the start-up, NG is flowed into the reactor and the NG autothermal reforming is allowed to reach a steady state or nearly steady-state. At any time after this point, the transition from NG to ethanol reforming may be undertaken by gradually increasing the input or flow of ethanol into the ATR while reducing the input or flow of NG into the reactor by a corresponding or nearly corresponding amount. The amounts of the various inputs are typically controlled by the control system described below. The ethanol flow rate is typically controlled by adjusting the pump speed, and the NG flow is typically controlled by a mass flow controller (not shown in FIG. 1).

The operating procedures typically involve first filling the ethanol feed tank to art appropriate level. NG reforming is conducted first with the valve V2 open and the pump P2 turned-off until the system gets hot (typically from about 600° C. to about 700° C., preferably 650° C. or so) and stable. Depending upon the unit and operating parameters this may take from about 2 to about 3 hours.

Next, the ethanol feed pump P2 is turned on to start the ethanol flow. The ethanol flow is gradually increased from a small value, for example, about 15 mL/min. to the default final ethanol flow, for example, about 51.3 mL/min, with an increment of from about 10 to about 15 mL/min. When ethanol flow is increased, the NG flow is usually reduced correspondently as further described below. During the transition the ATR reactor temperature is monitored and controlled at around 650° C. by, for example, adjusting the O₂/C and S/C ratio.

When the ethanol flowrate reaches its desired final value, for example, 51.3 mL/min, NG flow will be automatically changed to zero as described in relation to the controller below. At this time, the desired system S/C ratio is at, for example, 1.5 and the O2/C ratio is at, for example, 0.25. If the O₂/C ratio is too high, then reducing air or adding water or both may be required. In any event, the usual objective is to maintain the ATR reactor temperature stable. To meet this objective a means for maintaining a substantially stable autothermal reforming reactor temperature during the transition process is provided and described below.

Next, the H₂ concentration in the reformate is checked. The concentration is advantageously often close to 40% (dry base) which means that in this system that steady state of ethanol autothermal reforming has been reached.

For various systems it may be desirable to vary the S/C ratio and O₂/C ratio in order to study any corresponding changes of H₂concentration and ethanol conversion. Of course, the reactor temperature will also usually be changed when these ratios are varied. During the process, the goal is typically to optimize the operation conditions to achieve a high H₂ concentration in the reformate while minimizing the CO concentration.

To shut-down the unit, the operation is usually shifted back to NG reforming by reversing the above transition steps. It is often important to let the unit operate at least for another 30 minutes with NG reforming, before shutting it down as usual. The shift back to NG reforming will assist in avoiding ethanol-water build-up in the ATR reactor and its catalysts when shut-down. This is because typically when there is ethanol in the reactor there is water in the reactor also. Therefore, by shifting back to NG reforming, which is often a necessary step, the catalyst is protected.

Typically, to optimize the aforementioned process will comprise maintaining a ratio of S/C of from about 2.5 to about 3.5, a ratio of O₂/C of from about 0.2 to about 0.3, and a GHSV of from about 3750 hr⁻¹ to about 4250 hr⁻¹ when a substantial amount of the autothermal reforming reactor input comprises liquid fuel and wherein the liquid fuel is ethanol. Optimizing the aforementioned process may result in high ethanol conversion (often greater than about 98%, preferably greater than about 99%, more preferably greater than or equal to about 99.7%), high hydrogen concentration (typically greater than about 35%, often greater than about 45%, preferably greater than about 46%, more preferably greater than or equal to about 46.8%), and lower CO concentration (often less than about 3%, preferably less than or equal to about 2.6%) in the reformate. This is often indicative of good H₂ selectivity and thermal efficiency.

As shown in FIG. 1 the apparatus of the present invention typically comprises a mixer, a vaporizer, a superheater, an air preheater, an autothermal reactor, and a means for maintaining a substantially stable autothermal reforming reactor temperature during the transition process. The mixer, vaporizer, superheater, air preheater, and autothermal reactor may be any useful device used in conventional gaseous or liquid fuel reformation. Such equipment is described in, for example, U.S. Pat. Nos. 6,818,198: 6,878.362, U.S. Publication No. 2004/197238 A1; and WO 00/01613 incorporated herein by reference.

The apparatus comprises a means for maintaining a substantially stable autothermal reforming reactor temperature during the transition of gaseous fuel reformation to liquid fuel reformation. Any convenient component or combination of components may be employed to maintain a substantially stable autothermal reforming reactor temperature. Such component(s) may vary depending upon the gaseous and/or liquid fuel, the type of equipment, the desired temperature, pressures, and products. Typically, the means for maintaining the temperature comprises a control system. The control system assists in controlling, for example, the GHSV and the ratios of S/C and O₂/C. This may be accomplished by controlling, for example, the amount of fuel, air, and/or water.

A typical control system may comprise one or more flow controllers and one or more sensors which are implemented on a computing system. The flow controller may control one or more of the inputs selected from liquid fuel, gaseous fuel, water, and air. The sensor may sense the amount of one or more of the components of the system selected from liquid fuel, gaseous fuel, water, and air.

The control system may be implemented on a computing system comprising one ore more computers each of which may control some designated facet of the operation. Alternatively, the computing system may control all aspects of the operation not under manual control. The computing apparatus may be implemented as a desktop personal computer, a workstation, a notebook or laptop computer, an embedded processor, or the like.

The computing system typically includes a processor communicating with storage over a bus system. The storage may include a hard disk and/or random access memory (“RAM”) and/or removable storage such as a floppy magnetic disk and/or an optical disk. The storage is often encoded with a data structure storing the data set, an operating system, user interface software, and an application. The user interface software, in conjunction with a display, implements a user interface. The user interface may include peripheral I/O devices such as a key pad or keyboard, a mouse, or a joystick. The processor runs under the control of the operating system, which may be practically any operating system known to the art. The application is invoked by the operating system upon power up, reset, or both, depending on the implementation of the operating system 330.

The present invention employs a closed-loop control system whereby the one or more sensors monitor the amount of liquid fuel, gaseous fuel, water, and/or air. The monitored data is then sent to the computing system which instructs the flow controller to adjust and thereby input more or less of the liquid fuel, gaseous fuel, water, and/or air depending upon the monitored data. In this manner, the autothermal reforming reactor temperature may be substantially stable during the transition process.

The computing system necessarily includes a computer program that employs the monitored data from the sensors and instructs the flow controller in a manner that optimizes or nearly optimizes the autothermal reaction. For example, the computer program used for optimizing the ethanol autothermal reaction comprises employing universal formulas as part of the control system described above.

The universal formulas for calculating O2/C and S/C ratio for this dual fuel reforming case comprise:

$${O}_{2} / C ratio = \frac{( {Q}_{Air} * 0.21 ) * 28.3 / 22.4}{( \begin{matrix}{Q}_{NG , new} * ( 0.95 + 20.029 + 3 * 0.008 ) * \\ 28.3 / 22.4 + 2 * {Q}_{Et OH} * 0.8 / 46\end{matrix} )}$$

$$S / C ratio = \frac{{Q}_{water} / 18}{( \begin{matrix}{Q}_{NG , new} * ( 0.95 + 2 * 0.029 + 3 * 0.008 ) * \\ 28.3 / 22.4 + 2 * {Q}_{EtOH} * 0.8 / 46\end{matrix} )}$$

When pure ethanol reforming is reached, these two formulas can be reduced to:

$${O}_{2} / C ratio = \frac{( {Q}_{Air} * 0.21 ) * 28.3 / 22.4}{( 2 * {Q}_{EtOH} * 0.8 / 46 )}$$

$$S / C ratio = \frac{{Q}_{water} / 18}{( 2 * {Q}_{EtOH} * 0.8 / 46 )}$$

That is, the computer program may comprise employing the following steps or formulas to update air and water flow rate to ensure stable reactor temperature during the transition from NG to ethanol reforming. Guidelines to proper formulas to be implemented in the control code for calculating the updated flow for each species include:
Formulas for calculating how much ethanol flow Q_{EtOH} to be added:

Q_{EtOH}=(Q_{NG,original} Q_{NG,new})/0.02065
Formulas for calculating the updated air and water flow for different ethanol flow Q_{EtOH}:

Q_{Air}=22.4/28.3/0.21*(O₂/C)*(Q_{NG,new}*(0.95+2*0.029+3*0.008)*28.3/22.4+2*Q_{EtOH}* 0.8/46)

Q_{Water}=18*(S/C)*(Q_{NG new}*(0.95+2*0.029+3*0.008)*28.3/22.4+2*Q_{EtOH}*0.8/46)

where: Q_{EtOH} instantaneous ethanol flow added, mL/min;
Q_{NG,original} original natural gas flow, 1.25 SCFM;
Q_{NG,new} updated natural gas flow when ethanol added in; SCFM
Q_{Air} air flow rate before adding ethanol, 2.95 SCFM (based on O2/C ratio=0.48, and NG=1.25 SCFM)
Q_{Water} water flow rate, whose initial value is 73.3 mL/min (based on S/C ration=2.5 and NG=1.25 SCFM)
0.8 Ethanol density, g/cm³ or g/mL
46 Ethanol molecular weight.

The following is an example of control steps for migration from NG reforming at 1.25 SCFM initial flow rate and S/C=2.5, O2/C=0.48 to ethanol reforming: Step 1: When Q_{NG,new}=Q_{NG,original}=1.25 SCFM, Q_{EtOH}=0, this is the case of pure NG reforming, so the O2/C and S/C ratios should be kept unchanged, that is, O2/C=0.48, S/C=2.5, and Q_{Air} and Q_{Water} do not need to be updated, that is, keeping at their original values of Q_{Air}=2.95 SCFM, and Q_{Water}=73.3 mL/min. Step 2: When Q_{NG,new}=75% Q_{NG,original}=0.94 SCFM, Q_{EtOH}=15.1 mL/min, the ratios need, to be changed to O₂/C=0.42, and S/C=2.3, that is, Q_{Air} and Q_{Water} need to be updated using the formula (2) and (3), which are: Q_{Air}=2.77 SCFM, and Q_{Water}=72.4 mL/min. Step 3: When Q_{NG,new}=50% Q_{NG,original}=0.63 SCFM, Q_{EtOH}=30.3 mL/min, the ratios need to be changed to O2/C=0.36, and S/C=2.1, that is, Q_{Air} and Q_{Water} need to be updated using the formula above, which are: Q_{Air}=2.53 SCFM, and Q_{Water}=70.6 mL/min. Step 4: When Q_{NG,new}=25% Q_{NG,original}=0.31 SCFM, Q_{EtOH}=45.4 mL/min, the ratios need to be changed to O2/C=0.30, and S/C=1.9, that is, Q_{Air} and Q_{Water} need to be updated, which are: Q_{Air}=2.25 SCFM, and Q_{Water}=67.9 mL/min. Step 5: When Q_{NG,new}=0, Q_{EtOH}=51.3 mL/min, this is the case of pure ethanol reforming, and the ratios of control need to be changed to O2/C=0.25, and S/C=1.5, that is, Q_{Air} and Q_{Water} need to be updated using the formula above, which are: Q_{Air}=1.68 SCFM, and Q_{Water}=48.2 mL/min).

It should be noted that the aforementioned five migration steps are just guidelines. On each step, it may be necessary or desirable to determine exactly what air and water flow rate to be controlled or updated, as various reactors and equipment are different. In general, when a temperature increases due to the addition of some ethanol and removal of some NG, then more water and less air is usually necessary and vice versa.

Although only exemplary embodiments are specifically illustrated and described herein, it will be appreciated that many modifications and variations of the process and apparatus described herein are possible in light of the above teachings and within the purview of the appended claims without departing from the spirit and intended scope of the claimed subject matter.

This concludes the detailed description. The particular embodiments disclosed above are illustrative only for purposes of clarity of understanding, as the invention may be modified and practiced in different but equivalent manners apparent to those skilled in the art having the benefit of the teachings herein. Furthermore, no limitations are intended to the details of construction or design herein shown, other than as described in the claims below. It will be readily apparent to those of ordinary skill in the art in light of the teachings of this invention that certain changes and modifications may be made thereto without departing from the spirit or scope of the appended claims.

All publications and patent applications mentioned in this specification are herein incorporated by reference to the same extent as if each individual publication or patent application was specifically and individually indicated to be incorporated by reference.

What is claimed is:

1. A process for transitioning from gaseous fuel reformation to liquid fuel reformation in a reactor wherein said process comprises:
steadily reforming gaseous fuel by inputting the gaseous fuel into an autothermal reforming reactor;
reducing the gaseous fuel input into the autothermal reforming reactor while increasing the input of a vaporized, superheated liquid fuel/water mixture into the autothermal reforming reactor until a substantial amount of the autothermal reforming reactor input comprises liquid fuel; and
reforming the liquid fuel in the autothermal reforming reactor;
wherein the autothermal reforming reactor temperature is substantially stable during the transition process.

2. The process of claim 1 which comprises reducing the gaseous fuel input while increasing the input of a vaporized, superheated liquid fuel/water mixture in a series of control steps.

3. The process of claim 1 which comprises controlling the amount of air to maintain a substantially stable autothermal reforming reactor temperature.

4. The process of claim 1 which comprises controlling the amount of water to maintain, a substantially stable autothermal reforming reactor temperature.

5. The process of claim 1 which comprises controlling the amount of air and water to maintain a substantially stable autothermal reforming reactor temperature.

6. The process of claim 1 wherein the process comprises maintaining a ratio of S/C of from about 2.5 to about 3.5, a ratio of O₂/C of from about 0.2 to about 0.3, and a GHSV of from about 3750 hr⁻¹ to about 4250 hr⁻¹ when a substantial amount of the autothermal reforming reactor input comprises liquid fuel and wherein the liquid fuel is ethanol.

7. The process of claim 1 wherein the process comprises maintaining an autothermal reforming reactor temperature of from about 600 to about 700° C.

8. The process of claim 1 wherein the reformate comprises from about 35 to about 50% H₂.

9. The process of claim 1 wherein the liquid fuel is ethanol and the reformate comprises greater than about 45% H₂ and less than about 3% CO.

10. The process of claim 1 wherein the liquid fuel is ethanol and wherein the ethanol conversion is greater than about 99%.

11. The process of claim 1 wherein the liquid fuels are selected from the group consisting of C1-C6 alkanols.

12. The process of claim 1 wherein the liquid fuels are selected from methanol, ethanol, and propanol.

13. The process of claim 1 wherein the gaseous fuels are selected from the group consisting of natural gas or propane.

14. The process of claim 1 wherein the water mixed with the liquid fuel is deionized water.

15. The process of claim 1 wherein the liquid fuel/water mixture is superheated to at least about 375° C.

16. The process of claim 1 wherein the superheating comprises mixing the liquid fuel/water mixture with pre-heated air.

17. The process of claim 1 wherein the fuel reformation comprises biofuel reformation.

18. The process of claim 1 wherein the gaseous fuel comprises natural gas, the liquid fuel comprises ethanol, and a substantially stable autothermal reforming reactor temperature is maintained during the transition by controlling the amount of air and water flow.

19. An apparatus capable of transitioning from gaseous fuel reformation to liquid fuel reformation said apparatus comprising: a mixer, a vaporizer, a superheater, an air preheater, an autothermal reactor, and a means for maintaining a substantially stable autothermal reforming reactor temperature during the transition process.

20. The apparatus of claim 19 wherein the means for maintaining a substantially stable autothermal reforming reactor temperature during the transition process comprises a control system.

21. The apparatus of claim 20 wherein the control system comprises a flow controller, a sensor implemented on a computing system.

22. The apparatus of claim 21 further comprising a computer program that monitors data from the sensors and instructs the flow controller to adjust.

23. A process for transitioning from liquid fuel reformation to gaseous fuel reformation in a reactor wherein said process comprises:
steadily reforming liquid fuel by inputting the liquid fuel into an autothermal reforming reactor;
reducing the liquid fuel input into the autothermal reforming reactor while increasing the input of a vaporized, superheated gaseous fuel/water mixture into the autothermal reforming reactor until a substantial amount of the autothermal reforming reactor input comprises gaseous fuel; and
reforming the gaseous fuel in the autothermal reforming reactor;
wherein the autothermal reforming reactor temperature is substantially stable during the transition process.
